(19) United States
(12) Patent Application Publication
(10) Pub. No.: US 2004/0190900 A1
(43) Pub. Date: Sep. 30, 2004

(54) Optical network, optical network transmission apparatus, distributed routing control method used for the apparatus, and recording medium which records program for the method

(76) Inventor: Tomohiko Yagyu, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/803,953

(22) Filed: Mar. 19, 2004

(30) Foreign Application Priority Data
Mar. 26, 2003 (JP) 084035/2003

(51) Int. Cl. H04J 14/00

(52) U.S. Cl. 398/57

(57) ABSTRACT

An optical network is formed by a plurality of optical network transmission apparatuses and a plurality of transmission lines that connect the optical network transmission apparatuses. Each optical network transmission apparatus includes an advertisement unit which autonomously advertises a usable wavelength in a transmission line connected to the apparatus, and a collection unit which autonomously collects a usable wavelength in a transmission line that is advertised by another apparatus. An optical network transmission apparatus, a distributed routing control method used for the apparatus, and a recoding medium which records the program of the method are also disclosed.

### BACKGROUND OF THE INVENTION

The present invention relates to an optical network, an optical network transmission apparatus, a distributed routing control method used for the apparatus, and a program for the method and, more particularly, to a method of advertising a wavelength usable in an optical network and a route calculation method using pieces of information.

An optical network is conventionally comprised of a plurality of optical network transmission apparatuses (to be referred to as nodes or simply apparatuses hereinafter), and a plurality of transmission lines (to be referred to as links hereinafter) which connect these nodes.

To set an optical path in the optical network, the network administrator collects pieces of link information of apparatuses by using an NMS (Network Management System), and sets a path in consideration of the characteristics of the pieces of collected link information.

Distributed control of a network is recently proposed. A typical architecture is GMPLS (Generalized Multi Protocol Label Switching) (see, e.g., reference 1 (Eric Mannie et al., “Generalized Multi-Protocol Label Switching (GMPLS) Architecture”, Internet Draft, Work in Progress, draft-ietf-ccamp-gmpls-architecture-03.txt, August 2002.))

In GMPLS, a routing protocol which runs in each apparatus autonomously advertises and collects link information of the apparatus. Advertisement means notification of link information of an apparatus to all other apparatuses within a network. Collection means acquisition of pieces of link information of all other apparatuses within a network (see, e.g., reference 2 (K. Kompella et al., “Routing Extensions in Support of Generalized MPLS”, Internet Draft, Work in Progress, draft-ietf-ccamp-gmpls-routing-05.txt, August 2002.)) To calculate the route of an optical path, route calculation is executed on the basis of pieces of link information collected by the routing protocol, and path setting of each node is done by a signaling protocol (see, e.g., reference 3 (Lou Berger et al., “Generalized MPLS—Signaling Functional Description”, RFC3471, January 2003.))

Optical network apparatuses include an OADM (Optical Add Drop Multiplexor) apparatus and OXC (Optical Cross-Connect) apparatus. The OADM apparatus is an optical network apparatus capable of adding a specific wavelength (sending a specific wavelength to a link) and dropping a specific wavelength (receiving a specific wavelength from a link). The OXC apparatus is an optical network apparatus which switches an optical signal without any wavelength conversion.

There are apparatus limitations on setting an optical path such that the wavelength of a signal passing through an apparatus cannot be converted and an addable/droppable wavelength is restricted when OADM and OXC apparatuses coexist in the above-described conventional optical network. In the conventional optical network, no optical path free from wavelength conversion from the start point to the end point cannot be set unless a wavelength which can be added/dropped/transmitted in each apparatus is considered.

In techniques disclosed in references 1 to 3, the routing protocol cannot advertise limitations on the addable/droppable wavelength of an apparatus and limitations on the transmittable wavelength. In setting an optical path free from any wavelength conversion, these techniques cannot determine a wavelength usable at the start and end nodes of the path in route calculation. Path setting may fail at high possibility under apparatus limitations.

### SUMMARY OF THE INVENTION

The present invention has been made to overcome the conventional drawbacks, and has as its object to enable path setting by signaling in consideration of apparatus limitations including the usable wavelength of each apparatus.

To achieve the above object, according to the present invention, there is provided an optical network which is formed by a plurality of optical network transmission apparatuses and a plurality of transmission lines that connect the optical network transmission apparatuses, wherein each optical network transmission apparatus comprises advertisement means for autonomously advertising a usable wavelength in a transmission line connected to the apparatus, and collection means for autonomously collecting a usable wavelength in a transmission line that is advertised by another apparatus.

According to the present invention, there is provided an optical network transmission apparatus in which the apparatus and other adjacent apparatuses are connected by transmission lines, comprising advertisement means for autonomously advertising usable wavelengths in the transmission lines connected to the apparatus, and collection means for autonomously collecting usable wavelengths in transmission lines that are advertised by the other apparatuses.

According to the present invention, there is provided a distributed routing control method in an optical network which is formed by a plurality of optical network transmission apparatuses and a plurality of transmission lines that connect the optical network transmission apparatuses, comprising the step of causing each optical network transmission apparatus to autonomously advertise a usable wavelength in a transmission line connected to the apparatus, and autonomously collect a usable wavelength in a transmission line that is advertised by another apparatus.

### BRIEF DESCRIPTION OF THE DRAWINGS

FIG. 1 is a block diagram showing the arrangement of an optical network according to an embodiment of the present invention;

FIG. 2 is a block diagram showing the internal arrangement of a node;

FIG. 3 is a block diagram showing the arrangement of a routing unit;

FIG. 4 is a flow chart showing the flow of the internal operation of the node;

FIG. 5 is a view showing an example of link information exchanged by the routing protocol;

FIG. 6 is a block diagram showing the arrangement of an optical network which is formed by OADMs after the optical path is set at λ3 in the embodiment of the present invention; and

FIG. 7 is a block diagram showing the arrangement of an optical network according to another embodiment of the present invention.

### DESCRIPTION OF THE PREFERRED EMBODIMENTS

Preferred embodiments of the present invention will be described below with reference to the accompanying drawings.

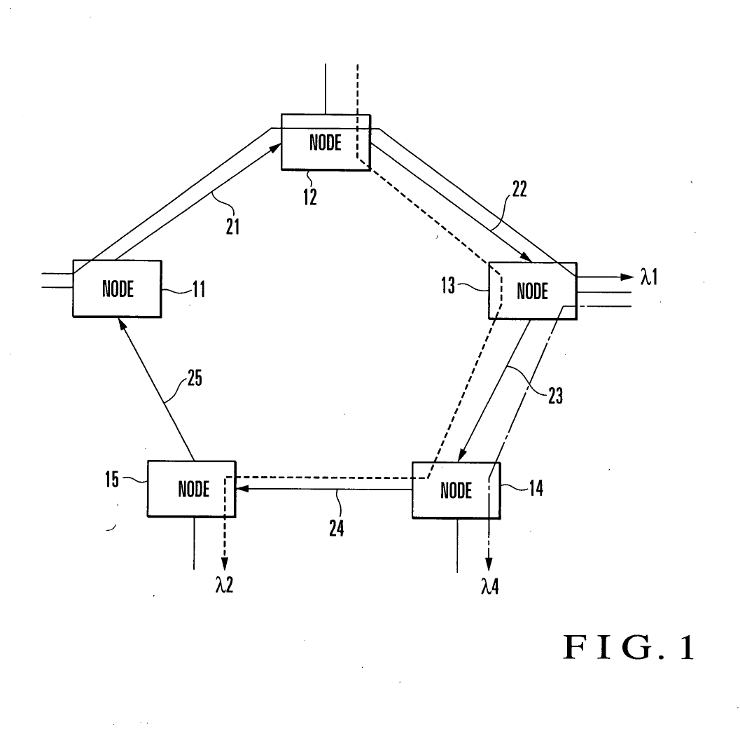

FIG. 1 shows the arrangement of an optical network according to an embodiment of the present invention. FIG. 1 illustrates OADM (Optical Add Drop Multiplexor) apparatuses which are configured in a ring shape (ring network). The optical network is comprised of nodes (optical network transmission apparatuses) 11 to 15 and a plurality of links (transmission lines) 21 to 25 which connect the nodes 11 to 15.

In an initial state, wavelengths which can be added/dropped by the nodes 11 to 15 are λ1 to λ5. The addable/droppable wavelength may change depending on the node. The OADM apparatus cannot convert a passing wavelength.

In FIG. 1, an optical path is formed from the node 11 to the node 13 at the wavelength λ1, an optical path is formed from the node 12 to the node 15 at the wavelength λ2, and an optical path is formed from the node 13 to the node 14 at the wavelength λ4. In this state, the nodes 11 to 15 have pieces of usable wavelength information shown in Table 1. Table 1 represents pieces of wavelength information usable at the nodes 11 to 15 in FIG. 1.

TABLE 1

| | | Addable | Droppable | Transmittable |
|---|---|---|---|---|
| | | Wavelength | Wavelength | Wavelength |
| Node 11 | Link 25 | — | λ 1, λ 2, λ 3, | λ 1, λ 2, λ 3, |
| | | | λ 4, λ 5 | λ 4, λ 5 |
| | Link 21 | λ 2, λ 3, λ 4, | — | λ 2, λ 3, λ 4, |
| | | λ 5 | | λ 5 |
| Node 12 | Link 21 | — | λ 2, λ 3, λ 4, | λ 2, λ 3, λ 4, |
| | | | λ 5 | λ 5 |
| | Link 22 | λ 3, λ 4, λ 5 | — | λ 3, λ 4, λ 5 |
| Node 13 | Link 22 | — | λ 3, λ 4, λ 5 | λ 3, λ 4, λ 5 |
| | Link 23 | λ 1, λ 3, λ 5 | — | λ 1, λ 3, λ 5 |
| Node 14 | Link 23 | — | λ 1, λ 3, λ 5 | λ 1, λ 3, λ 5 |
| | Link 24 | λ 1, λ 3, λ 4, | — | λ 1, λ 3, λ 4, |
| | | λ 5 | | λ 5 |
| Node 15 | Link 24 | — | λ 1, λ 3, λ 4, | λ 1, λ 3, λ 4, |
| | | | λ 5 | λ 5 |
| | Link 25 | λ 1, λ 2, λ 3, | — | λ 1, λ 2, λ 3, |
| | | λ 4, λ 5 | | λ 4, λ 5 |

In Table 1, the node 11 has droppable wavelengths “λ1, λ2, λ3, λ4, and λ5” and transmittable wavelengths “λ1, λ2, λ3, λ4, and λ5” the link 25, and addable wavelengths “λ2, λ3, λ4, and λ5” and transmittable wavelengths “λ2, λ3, λ4, and λ5”]in the link 21.

The node 12 has droppable wavelengths “λ2, λ3, λ4, and λ5” and transmittable wavelengths “λ2, λ3, λ4, and λ5” in the link 21, and addable wavelengths “λ3, λ4, and λ5” and transmittable wavelengths “λ3, λ4, and λ5” in the link 22.

The node 13 has droppable wavelengths “λ3, λ4, and λ5” and transmittable wavelengths “λ3, λ4, and λ5” in the link 22, and addable wavelengths “λ1, λ3, and λ5” and transmittable wavelengths “λ1, λ3, and λ5” in the link 23.

The node 14 has droppable wavelengths “λ1, λ3, and λ5” and transmittable wavelengths “λ1, λ3, and λ5” in the link 23, and addable wavelengths “λ1, λ3, λ4, and λ5” and transmittable wavelengths “λ1, λ3, λ4, and λ5” in the link 24.

The node 15 has droppable wavelengths “λ1, λ3, λ4, and λ5” and transmittable wavelengths “λ1, λ3, 4, and λ5” in the link 24, and addable wavelengths “λ1, λ2, λ3, λ4, and λ5” and transmittable wavelengths “λ1, λ2, λ3, λ4, and λ5” in the link 25.

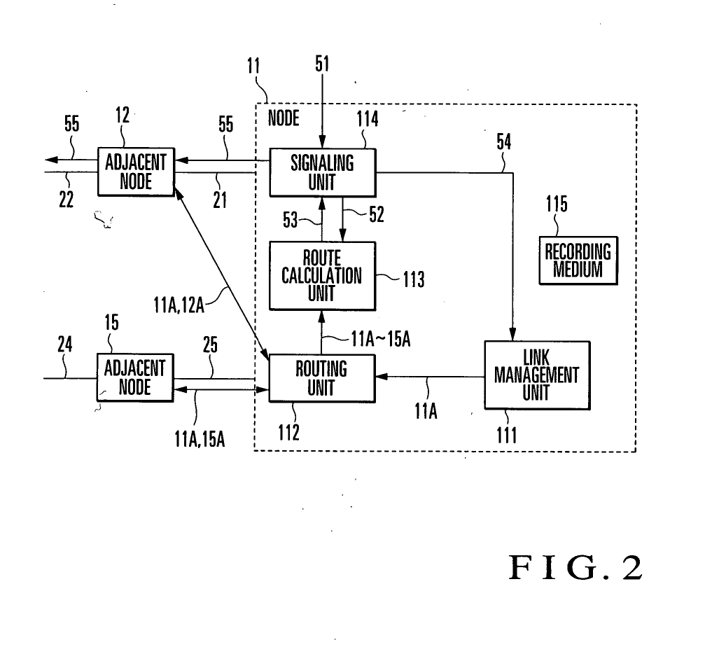

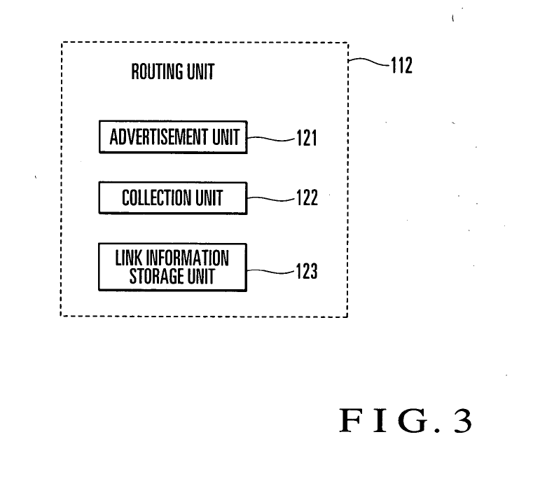

FIG. 2 shows the internal arrangement of the node 11 in FIG. 1. The node 11 is formed by a computer, and realizes a link management unit 111, routing unit 112, route calculation unit 113, and signaling unit 114 by executing a predetermined program. As shown in FIG. 3, the routing unit 112 comprises an advertisement unit 121 which autonomously advertises link information 11A of an apparatus, a collection unit 122 which autonomously collects pieces of link information advertised by other apparatuses, and a link information storage unit 123 which stores pieces of collected link information. A program which realizes each unit of the node 11 may be stored and provided in a recording medium 115 such as a CD-ROM or hard disk. Although not shown, the remaining nodes 12 to 15 have the same arrangement as that of the node 11.

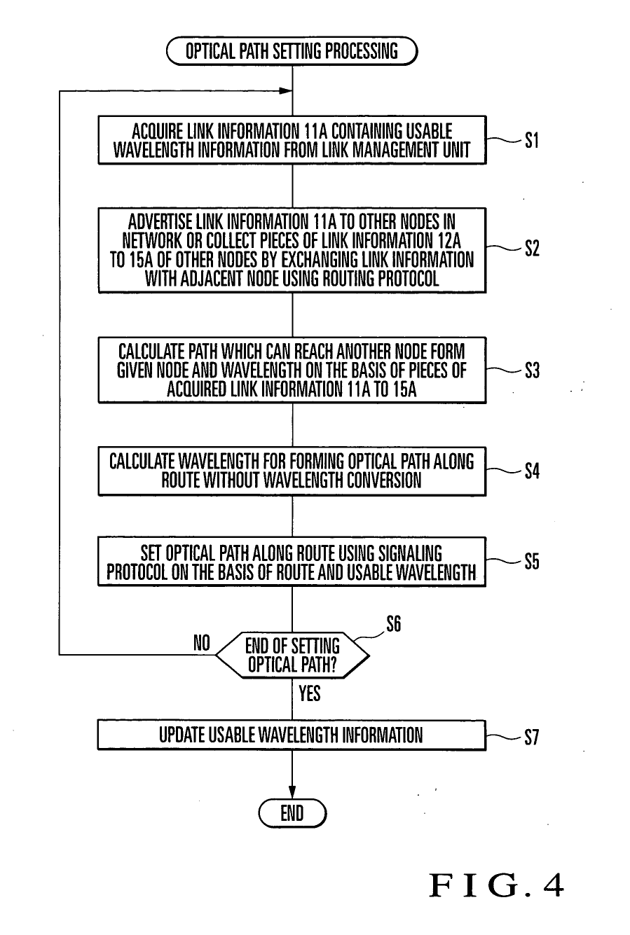

The internal operation of the node 11 will be explained with reference to FIGS. 1 to 4. FIG. 4 shows the flow of the internal operation of the node 11. The operation shown in FIG. 4 is implemented by executing a program in the recording medium 115 by the computer which constitutes the node 11.

In the node 11, the link management unit 111 manages information on the node 11 shown in Table 1. The routing unit 112 acquires from the link management unit 111 the link information (adjacent node, link number, band information, and the like) 11A containing pieces of wavelength information usable in the links 25 and 21 connected to the node 11 (step S1 in FIG. 4). The link information 11A is stored in the link information storage unit 123 of the routing unit 112.

The routing unit 112 exchanges pieces of link information with the adjacent nodes 12 and 15 by using the routing protocol. More specifically, the advertisement unit 121 of the routing unit 112 notifies the adjacent nodes 12 and 15 of the link information 11A. The collection unit 122 of the routing unit 112 acquires, from the adjacent nodes 12 and 15, pieces of link information 12A and 15A containing pieces of wavelength information usable in links connected to these nodes. At this time, when the collection unit 122 acquires link information of another node, the routing unit 112 also exchanges this link information. Exchange of link information between adjacent nodes is repeated in all nodes within the optical network. The node 11 can advertise the link information 11A to the remaining nodes 12 to 15 in the optical network, and collect all pieces of link information 12A to 15A advertised by the remaining nodes 12 to 15 (step S2 in FIG. 4). The pieces of collected link information 12A to 15A of the remaining nodes 12 to 15 are stored in the link information storage unit 123 of the routing unit 112. The pieces of link information 11A to 15A of all the nodes 11 to 15 which are stored in the link information storage unit 123 are transferred to the route calculation unit 113.

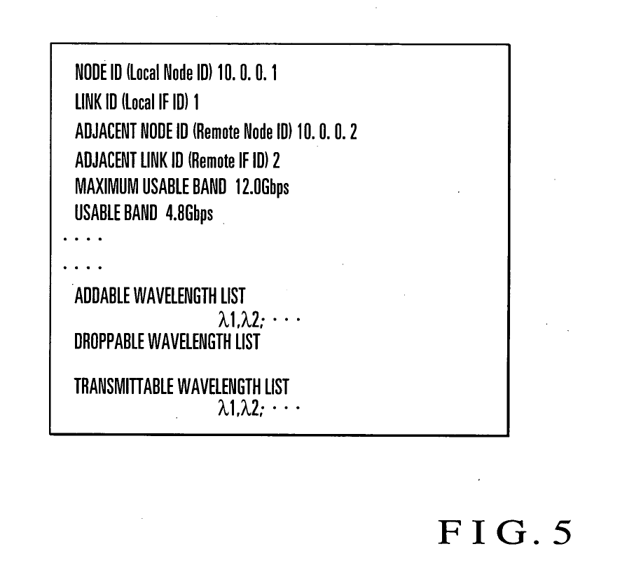

FIG. 5 shows an example of link information exchanged by the routing protocol. In FIG. 5, the link information contains “node ID (Local Node ID): 10.0.0.1”, “link ID (Local IF ID): 1”, “adjacent node ID (Remote Node ID): 10.0.0.2”, “adjacent link ID (Remote IF ID): 2”, “maximum usable band: 12.0 Gbps”, “usable band: 4.8 Gbps”, . . . , “addable wavelength list: λ1, λ2, . . . ”, “droppable wavelength list: none”, and “transmittable wavelength list: λ1, λ2, . . . ”.

Assume that an optical path setting request 51 from the node 11 to the node 14 is issued to the node 11. The signaling unit 114 of the node 11 issues a request 52 to the route calculation unit 113 so as to calculate a route up to the node 14 and a usable wavelength. The route calculation unit 113 calculates a route which can reach the node 14 from the node 11 and a wavelength on the basis of the pieces of link information 11A to 15A which are acquired from the routing unit 112 (step S3 in FIG. 4).

In this case, the route from the node 11 to the node 14 is only {node 11-link 21-node 12-link 22-node 13-link 23-node 14}. The addable wavelength of the node 11 to the link 21 includes λ2 to λ5. The transmittable wavelength of the node 12 to the link 21 includes λ2 to λ5, and the transmittable wavelength of the node 12 to the link 22 includes λ3 to λ5. The transmittable wavelength of the node 13 to the link 22 includes λ3 to λ5, and the transmittable wavelength of the node 13 to the link 23 includes λ1, λ3, and λ5. The droppable wavelength of the node 14 from the link 23 includes λ1, λ3, and λ5.

It can be calculated that the wavelength λ3 or λ5 is used to form an optical path along this route without any wavelength conversion (step S4 in FIG. 4).

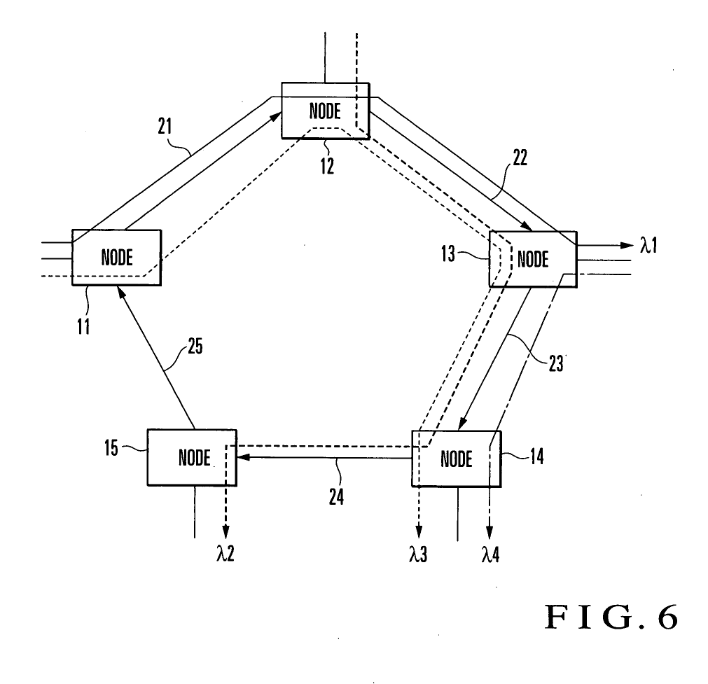

The route calculation unit 113 sends back information 53 containing the route and the usable wavelengths λ3 and λ5 to the signaling unit 114. The signaling unit 114 sets an optical path along the route by using the signaling protocol (step S5 in FIG. 4). In this case, an optical path is set using the wavelength λ3. FIG. 6 shows a network after the optical path is set using the wavelength λ3.

After the end of setting the optical path (YES in step S6 of FIG. 4), the signaling unit 114 sends to the link management unit 111 a notification 54 that the path has been set using the wavelength λ3. Upon reception of the notification 54, the link management unit 111 deletes λ3 from the usable wavelength information to update the link information 11A (step S7 in FIG. 4).

The signaling unit 114 sends to the adjacent node 12 a signaling message 55 that the optical path has been set using the wavelength λ3 along the route of the nodes 11 to 14. The message 55 is transferred up to the node 14. The nodes 12 to 14 which have received the message 55 delete λ3 from the usable wavelength information to update the pieces of link information 12A to 14A.

Pieces of usable wavelength information after setting an optical path are shown in Table 2. Table 2 represents pieces of wavelength information usable at the nodes 11 to 15 in FIG. 6.

TABLE 2

| | | Addable | Droppable | Transmittable |
|---|---|---|---|---|
| | | Wavelength | Wavelength | Wavelength |
| Node 11 | Link 25 | — | λ 1, λ 2, λ 3, | λ 1, λ 2, λ 3, |
| | | | λ 4, λ 5 | λ 4, λ 5 |
| | Link 21 | λ 2, λ 4, λ 5 | — | λ 2, λ 4, λ 5 |
| Node 12 | Link 21 | — | λ 2, λ 4, λ 5 | λ 2, λ 4, λ 5 |
| | Link 22 | λ 4, λ 5 | — | λ 4, λ 5 |
| Node 13 | Link 22 | — | λ 4, λ 5 | λ 4, λ 5 |
| | Link 23 | λ 1, λ 5 | — | λ 1, λ 5 |
| Node 14 | Link 23 | — | λ 1, λ 5 | λ 1, λ 5 |
| | Link 24 | λ 1, λ 3, λ 4, | — | λ 1, λ 3, λ 4, |
| | | λ 5 | | λ 5 |
| Node 15 | Link 24 | — | λ 1, λ 3, λ 4, | λ 1, λ 3, λ 4, |
| | | | λ 5 | λ 5 |
| | Link 25 | λ 1, λ 2, λ 3, | — | λ 1, λ 2, λ 3, |
| | | λ 4, λ 5 | | λ 4, λ 5 |

In Table 2, the node 11 has droppable wavelengths λ1, λ2, λ3, λ4, and λ5” and transmittable wavelengths “λ1, λ2, λ3, λ4, and λ5” the link 25, and addable wavelengths “λ2, λ4, and λ5” and transmittable wavelengths “λ2, λ4, and λ5” in the link 21.

The node 12 has droppable wavelengths “λ2, λ4, and λ5” and transmittable wavelengths “λ2, λ4, and λ5” in the link 21, and addable wavelengths “λ4 and λ 5” and transmittable wavelengths “λ4 and λ5” in the link 22.

The node 13 has droppable wavelengths “λ4 and λ5” and transmittable wavelengths “λ4 and λ5” in the link 22, and addable wavelengths “λ1 and λ5” and transmittable wavelengths “λ1 and λ5” in the link 23.

The node 14 has droppable wavelengths “λ1 and λ5” and transmittable wavelengths “λ1 and λ5” in the link 23, and addable wavelengths “λ1, λ3, λ4, and λ5” and transmittable wavelengths “λ1, λ3, λ4, and λ5” in the link 24.

The node 15 has droppable wavelengths “λ1, λ3, λ4, and λ5” and transmittable wavelengths “λ1, λ3, λ4, and λ5” in the link 24, and addable wavelengths “λ1, λ2, λ3, λ4, and λ5” and transmittable wavelengths “λ1, λ2, λ3, λ4, and λ5” in the link 25.

When the optical path is released, the signaling unit 114 sends to the link management unit 111 a notification that the path using the wavelength λ3 has been released. Upon reception of this notification, the link management unit 111 adds λ3 to the usable wavelength information to update the link information 11A.

In the embodiment, the usable wavelengths of the nodes 11 to 15 are advertised and collected by autonomous distribution, and pieces of advertised/collected information are shared. In optical path route calculation, calculation is done using the pieces of information as limitations. The wavelength resource can be efficiently utilized, preventing any failure caused by apparatus limitations on path setting by signaling.

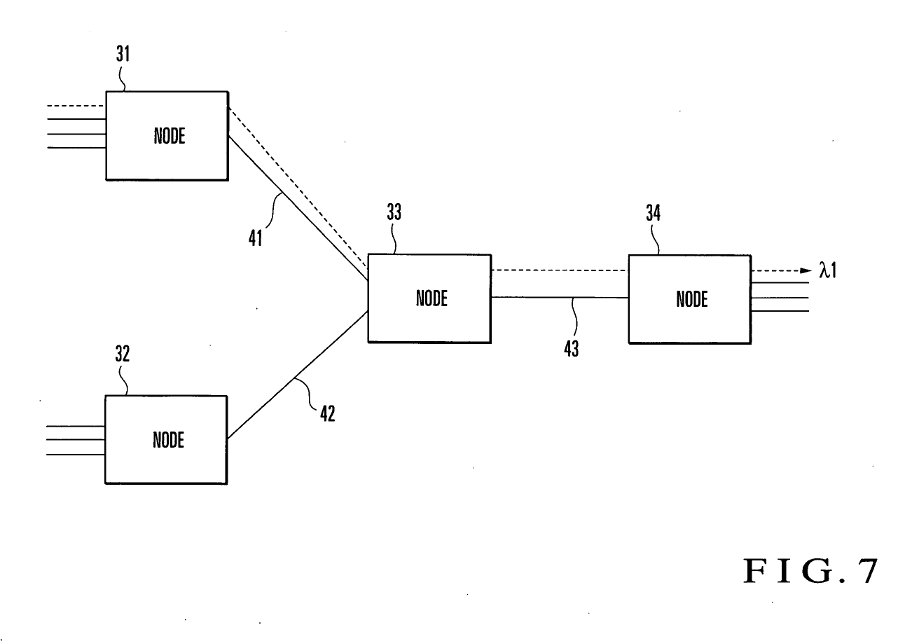

FIG. 7 shows the arrangement of an optical network according to another embodiment of the present invention. FIG. 7 illustrates an optical network (mesh network) constituted by OXC (Optical Cross-Connect) apparatuses. The optical network is comprised of nodes 31 to 34 and a plurality of links 41 to 43 which connect the nodes 31 to 34.

The node 33 is an OXC apparatus which cannot convert any wavelength, and an optical path is set using the wavelength λ1 from the node 31 to the node 34. At this time, the node 33 advertises, to the links 41, 42, and 43, usable wavelength information containing “usable wavelength of the link 41: λ2 and λ3”, “usable wavelength of the link 42: λ1, λ2, and λ3”, and “usable wavelength of the link 43: λ2 and λ3”.

When a request to form an optical path from the node 32 to the node 34 is received, the node 32 refers to the usable wavelength information advertised by the node 33, selects a wavelength which can reach the node 34, and sets a path. This advertisement method, path setting method, and the like are the same as those described in the above embodiment of the present invention.

As described above, according to the embodiment, the wavelength resource can be efficiently utilized, preventing any failure caused by apparatus limitations on path setting by signaling.

What is claimed is:

1. An optical network which is formed by a plurality of optical network transmission apparatuses (11-15) and a plurality of transmission lines (21-25) that connect the optical network transmission apparatuses, characterized in that
each optical network transmission apparatus comprises
advertisement means (121) for autonomously advertising a usable wavelength in a transmission line connected to the apparatus, and
collection means (122) for autonomously collecting a usable wavelength in a transmission line that is advertised by another apparatus.

2. A network according to claim 1, wherein said advertisement means comprises notification means for notifying another apparatus adjacent to the apparatus of the usable wavelength in the transmission line connected to the apparatus and the usable wavelength in the transmission line that is collected by said collection means.

3. A network according to claim 1, wherein the optical network transmission apparatus further comprises route calculation means (113) for calculating a route of an optical path on the basis of the usable wavelength in the transmission line connected to the apparatus and the usable wavelength in the transmission line that is collected by said collection means.

4. A network according to claim 1, wherein the optical network transmission apparatus comprises
wavelength management means (111) for managing the usable wavelength in the transmission line connected to the apparatus, and
wavelength update means (114) for updating the usable wavelength managed by said usable wavelength management means when an optical path is set in the transmission line connected to the apparatus.

5. An optical network transmission apparatus (11) in which the apparatus (11) and other adjacent apparatuses (12, 15) are connected by transmission lines (21, 25), characterized by comprising:
advertisement means (121) for autonomously advertising usable wavelengths in the transmission lines connected to the apparatus; and
collection means (122) for autonomously collecting usable wavelengths in transmission lines (22, 24) that are advertised by said other apparatuses.

6. An apparatus according to claim 5, wherein said advertisement means comprises notification means for notifying said other apparatuses of the usable wavelengths in the transmission lines connected to the apparatus and the usable wavelengths in the transmission lines that are collected by said collection means.

7. An apparatus according to claim 5, further comprising route calculation means (113) for calculating a route of an optical path on the basis of the usable wavelengths in the transmission lines connected to the apparatus and the usable wavelengths in the transmission lines that are collected by said collection means.

8. An apparatus according to claim 1, further comprising:
wavelength management means (111) for managing the usable wavelengths in the transmission lines connected to the apparatus; and
wavelength update means (114) for updating the usable wavelengths managed by said usable wavelength management means when an optical path is set in the transmission lines connected to the apparatus.

9. A distributed routing control method in an optical network which is formed by a plurality of optical network transmission apparatuses (11-15) and a plurality of transmission lines (21-25) that connect the optical network transmission apparatuses, characterized by comprising the step (S2) of causing each optical network transmission apparatus to autonomously advertise a usable wavelength in a transmission line connected to the apparatus, and autonomously collect a usable wavelength in a transmission line that is advertised by another apparatus.

10. A method according to claim 9, wherein the advertisement step comprises the step of notifying another apparatus adjacent to the apparatus of the usable wavelength in the transmission line connected to the apparatus and the collected usable wavelength in the transmission line.

11. A method according to claim 9, further comprising the step (S3, S4) of calculating a route of an optical path on the basis of the usable wavelength in the transmission line connected to the apparatus and the collected usable wavelength in the transmission line.

12. A method according to claim 9, further comprising:
the step (S5) of setting an optical path along a route obtained by route calculation; and
the step (S6) of updating the usable wavelength in the transmission line connected to the apparatus.

13. A machine-readable recording medium which records a program of a distributed routing control method in an optical network which is formed by a plurality of optical network transmission apparatuses (11-15) and a plurality of transmission lines (21-25) that connect the optical network transmission apparatuses, characterized in that the recording medium records a program for executing a process (S2) of autonomously advertising a usable wavelength in a transmission line connected to each apparatus, and autonomously collecting a usable wavelength in a transmission line that is advertised by another apparatus.

14. A medium according to claim 13, wherein the program executes, as the advertisement process, a process of notifying another apparatus adjacent to the apparatus of the usable wavelength in the transmission line connected to the apparatus and the collected usable wavelength in the transmission line.

15. A medium according to claim 13, wherein the program further executes a process (S3, S4) of calculating a route of an optical path on the basis of the usable wavelength in the transmission line connected to the apparatus and the collected usable wavelength in the transmission line.

16. A medium according to claim 13, wherein the program further executes
a process (S5) of setting an optical path along a route obtained by route calculation, and
a process (S6) of updating the usable wavelength in the transmission line connected to the apparatus.
